(19) United States
(12) Patent Application Publication
(10) Pub. No.: US 2014/0300116 A1
(43) Pub. Date: Oct. 9, 2014

(54) System For Interlocking and Unlocking a Sliding Door

(71) Applicants: Alexander Hellwig, Ennepetal (DE); Tim Wulbrandt, Schwelm (DE)

(72) Inventors: Alexander Hellwig, Ennepetal (DE); Tim Wulbrandt, Schwelm (DE)

(21) Appl. No.: 14/243,375

(22) Filed: Apr. 2, 2014

(30) Foreign Application Priority Data
Apr. 3, 2013 (DE) 102013103316.4

(51) Int. Cl. E05B 47/00

(52) U.S. Cl. CPC E05B 47/0001
USPC 292/336.3

(57) ABSTRACT

A system for interlocking and unlocking a sliding door includes a handle, attachable flush-mountably to the sliding door. The handle has an electro-mechanical locking mechanism attachable in a wall-mount manner, and having a movable locking element movable between a protracted locking position and a retracted releasing position, and an electronic drive, incorporated into the locking mechanism and in operative connection with the locking element. The handle is manually movable between an opening position and a closing position, the handle and the locking mechanism cooperate such that, in the locking position of the locking element and in the closing position of the handle, movement of the sliding door from a closed location in the direction of an opening location can be blocked and, in the opening position of the handle, movement of the sliding door can be effected from the closed location in the direction of the opening location.

### BACKGROUND OF THE INVENTION

1. Field of the Invention

The invention relates to a system for interlocking and unlocking a sliding door.

2. Description of the Related Art

Sliding doors, equipped with a handle in order to interlock or unlock the sliding door by a movement of the handle, are known in the state-of-the-art. It is disadvantageous in these handles that they protrude like a projection from the plane of the sliding door, whereby the user risks colliding with the handle. In addition, it has been proven that the overall construction for interlocking and unlocking the sliding door is too complicated. In particular with very thin doors, which, e.g. in their closed location, completely disappear in a wall channel, the handles known from the state-of-the-art can not be employed or incorporated on account of their complexity. In other words, this means that known systems for interlocking and unlocking the sliding door feature certain dimensions, which, in particular with very thin doors having a small door thickness, such as for example glass doors, can not be utilized.

Furthermore, it has been proven that the ease of actuating a sliding door, in particular for interlocking and/or unlocking the sliding door needs to be improved.

### SUMMARY OF THE INVENTION

An object of the present invention is to avoid the above mentioned disadvantages, in particular to provide a system for interlocking or unlocking a sliding door, wherein the system is suitable to be incorporated into doors having a small thickness, whereby simultaneously the ease of operation of the system is improved.

The problem of the present invention is solved by, in one aspect, a system for interlocking and unlocking a sliding door, provided with a handle, which can be attached essentially flush-mount to the sliding door, with an electro-mechanical locking mechanism attachable in a wall-mount manner, which has a movable locking element, movable between a protracted locking position and a retracted releasing position, with an electronic drive, incorporated into the locking mechanism and in operative connection with the locking element, wherein the handle is manually movable between an opening position and a closing position, in which the handle and the locking mechanism cooperate in such a way that, in the locking position of the locking element and in the closing position of the handle, a movement of the sliding door from a closed location in the direction of the opening location can be blocked and, in the opening position of the handle, a movement of the sliding door can be effected from a closed location in the direction of the opening location, and with at least one manually accessible sensor module, which has a defined detection area, the electronic drive being in data communication with the sensor module such that a detection of a user in the detection area can move the locking element into at least one of its positions.

One essential advantage of the invention is that the handle, including its mechanism, which is incorporated within the sliding door, has a flat and/or narrow overall construction, which thus can be in particular advantageously utilized with small door thicknesses. The locking mechanism is disposed on a wall such that in particular the movable locking element is positioned such as to be movable on the wall side, and, depending on its position, to enable a movement of the sliding door, respectively to block a movement of the sliding door. The flush-mount embodiment of the handle favors the provision that no protruding components are present at the sliding door. On the one hand, via a movement by hand, the inventive system is suitable to manually effect a movement of the sliding door from the closed location in the direction of the opening location. Additionally, the invention comprises the fact that the locking element can be brought into its respective position by the manually accessible sensor module. In other words, the user can move into the detection area of the sensor module and will be detected by the sensor module. The electro-mechanical locking mechanism receives corresponding information from the sensor module, in particular a signal that the user entered the detection area such that the electronic drive can move the locking element into one of its two positions. The sensor module may be disposed, e.g., on one side of the sliding door. It is likewise conceivable that respectively one sensor module is disposed on either side of the sliding door.

Advantageously, the inventive system has a control unit, which is in signalling communication with the at least one sensor module. It is for example conceivable that the control unit issues preferences specifying which one of the two sensor modules can be activated by the user. The invention may comprise, for example, the provision that from that side of the sliding door, from where an interlocking was performed, an unlocking can be carried out only by the sensor module. As an alternative and/or in addition, it is, for example, conceivable that exclusively authorized individuals can perform an activation of the sensor module. It is conceivable in this context that an authentication query between the inventive system, in particular the sensor module and the user occurs prior to activating the electro-mechanical locking mechanism, in order to correspondingly move the locking element.

Advantageously, the sensor module may feature a touch sensor and/or a proximity sensor, in particular that the sensor module is configured to recognize at least one defined pattern of movement of the user. The touch sensor may comprise e.g. a piezo-electric sensor such that the sensor module is able to detect a contact. The proximity sensor may detect an approach to the sensor module in a capacitive manner. Other sensors, for example optical sensors, are likewise conceivable to recognize the user in the detection area. Furthermore, the sensor module may be configured in that exclusively defined patterns of movement are necessary in order to be able to activate the locking mechanism accordingly for moving the locking element into its respective position. The sensor module may be disposed, e.g., on the wall side. The inventive system comprises likewise the provision that the sensor module is disposed at the sliding door, in particular in the vicinity of the handle. It is likewise provided in the inventive system that the sensor module is incorporated into the handle and/or into the locking mechanism.

Advantageously, the handle can be disposed in the area of the sliding door which faces the locking mechanism disposed on the wall side. The handle is configured, e.g., with a knob which the user can operate. The knob may be configured as a sliding knob or else as a rotary knob. Advantageously, the knob is disposed in a knob depression of the handle such that the handle is disposed almost flush, in particular flush-mount at the sliding door. Thus, a compact overall construction can be created at the sliding door. The inventive system may be configured in that the handle can be operated from both sides of the sliding door. This means that respectively one handle with a knob is provided on either side of the sliding door. By operating the knob, the handle is manually movable between the opening position and the closing position. In the opening position, the sliding door can be displaced from the closed location into the opening location. This means that in the opening position of the handle, the locking element of the locking mechanism does not block a movement of the sliding door.

According to the invention, the system may be configured in that the handle and the locking mechanism cooperate such that in the locking position of the locking element a transfer of the handle into the opening position can be effected, whereby a movement of the sliding door from the closed location into the opening location is enabled. The particularity of this embodiment resides in the provision that the locking element can remain in the locking position in order to move the sliding door in the direction of the opening location. For this purpose, it is sufficient to transfer the handle into the opening position. In an alternative embodiment, an inventive system comprises the provision that, exclusively in the releasing position of the locking element, the sliding door can be moved in the direction of the opening location, wherein prior to this, the handle is to be moved into the opening position.

In a measure enhancing the invention, sensory electronics may be provided which recognize the position of the handle, whereby, depending on the position of the handle, the locking element can be electronically moved between the locking position and the releasing position. It is for example conceivable that the sensory electronics feature a micro-switch, which can be operated by moving the handle. The invention likewise comprises the provision that the sensory electronics feature a magnetic element, which is in particular disposed at the handle, wherein the sensory electronics feature a sensor element which is suitable to detect the position of the magnetic element. According to the invention, it is conceivable that the sensor element consists of a magnetic switch or of a Hall sensor. The advantage of the sensory electronics resides in the fact that a reliable recognition of the position of the handle can be performed.

Furthermore, it may be provided according to the invention that the handle is mechanically connected to a movable lever element, which, in the closed position of the handle, is blocked by the locking element in the locking position and prevented from moving, together with the sliding door, from the closing position in the direction of the opening position. Advantageously, the lever element is located within the handle in the area which is not visible for the user. By a movement of the handle, the lever element can be moved from a locking position into a releasing position and vice versa. In the blocking position of the lever element, the locking element blocks a movement of the sliding door from the closing position into the opening position. In the releasing position of the lever element, the lever element is spaced apart from the locking element, which is in its locking position, such that a movement of the sliding door from the closing position into the opening position is possible. Advantageously, by a movement of the handle into its respective position, the lever element is movable while pivoting about an axis.

Advantageously, the lever element may have a crescent-shaped contour at which the handle engages during its movement. The inventive system comprises for example the provision that the handle features a cam, which cooperates with the crescent-shaped contour such that, by a movement of the cam of the handle, the cam slides along the crescent-shaped contour and simultaneously moves the lever element in the direction of the blocking position and/or of the releasing position.

Advantageously, at the side facing the locking element, the lever element has a contact surface, which, in the closing position of the handle, engages, in particular contacts the locking element, if the latter is in the locking position. The contact surface forms an abutment for the locking element, if, in the closing position of the handle, the sliding door is moved in the direction of the opening location. It is only once the locking element is located in the releasing position, that the path for the contact surface is clear, in order to move the sliding door with the handle in the direction of the opening location. Advantageously, the contact surface together with the lever element form one common component, in particular a monolithic component. Due to reasons of stability, it is advantageous that the lever element be configured from a metal. The lever element may be for example a stamped metal part.

Furthermore, the inventive system comprises the provision that the handle is in such an operative connection with the lever element that, in the opening position of the handle, the lever element is disengaged from the locking element which is located in the locking position, such that a movement of the sliding door from the closed location into the opening location can be performed. Thus, it is conceivable that, in the opening position of the handle, the contact surface of the lever element is so far spaced apart from the locking element that the sliding door can be moved from the closed location into the opening location.

Furthermore, the inventive system may comprise a locking mechanism with a support element, at which the drive is disposed, wherein the drive is in operative connection with a movable bracket. The support element serves the purpose of disposing the electronic drive within the locking mechanism in a space-saving manner. The movable bracket is in operative connection with the locking element such that the locking element can be simultaneously moved along with a movement of the bracket, whereby the transfer of the locking element from the locking position into the releasing position can be realized and vice versa.

Advantageously, it may be provided that the bracket is connected to the support element via a cam, which is in operative connection with the drive, wherein in particular the bracket features a first guiding contour and the support element features a second guiding contour, wherein the cam is supported to be movable in both guiding contours. The bracket is moved by the movement of the cam, whereby the locking element is brought into its corresponding position. The cam represents a reliably functioning structural component within the locking mechanism, in order to transfer the force from the drive onto the bracket, in particular onto the locking element in a low-noise as well as a low-wear manner.

The two guiding contours may be, e.g., oblong holes, which are machined into the bracket and/or into the support element. Advantageously, the guiding contours feature a linear extension, wherein the geometrical dimensions of the guiding contours match the geometry of the cam such that the cam is able to reliably slide back and forth within the two guiding contours. Advantageously, the second guiding contour is oriented to be slanted with regard to the first guiding contour. It is thereby achieved that, in the activated condition of the electronic drive, the cam moves in both guiding contours of the bracket, respectively of the support element, wherein only the bracket moves in relation to the support element, whereby the locking element can be moved between its locking position and the releasing position. Advantageously, the support element together with the drive remains rigid and immobile in its position.

In a measure enhancing the invention, the bracket may be supported to be rotatable about an axis, wherein in particular the axis is disposed at the side of the bracket facing away from the locking element. In another embodiment of the invention, for the purpose of an emergency unlocking, the bracket may be pivotable together with the support element. It is conceivable in this case, that the bracket, as well as the support element are pivotable about their common axis. An emergency unlocking may be necessary, e.g., in case, in the opening location of the sliding door, the locking element is in the locking position and operating the electronic drive for moving the locking element is not possible. A power failure may require, e.g., an emergency unlocking. In the opening location of the sliding door, the user may push the protruding locking element manually in the direction of the releasing position, wherein simultaneously the bracket as well as the support element are moved along within the locking mechanism, and namely so far until the locking element is located in the releasing position. In the event of an emergency unlocking, the cam remains immobile in the position within the guiding contours of both the bracket and the support element. Subsequently, the sliding door can be moved into the closed location because the locking element does not cause any collision with the sliding door, in particular not with the handle.

An end piece, which features a ramp, that is in particular oriented towards the locking element, may be provided in the area of the contact surface of the lever element. The end piece is configured in the shape of a door latch-bolt. In the event of an emergency unlocking, the end piece has the function of allowing the sliding door to be displaced in the direction of the closed location and that, in a defined position of the sliding door, the slanted end piece reaches contact with the locking element which is located in the locking position. Upon further movement of the sliding door into the closed location, the slanted end piece pushes the locking element further in the direction of the releasing position, wherein simultaneously the bracket and the support element pivot within the locking mechanism. In one possible embodiment of the invention, the end piece is attached to the lever element, which means that both structural components may be configured from different materials. It is conceivable that both the end piece and the lever element may be a two-component structural part. The end piece may be configured, e.g., from a plastic material, wherein the lever element may be formed from a metallic material. The application of an end piece made from plastic material will allow for a low-noise cooperation with the locking element.

In one embodiment of the inventive system, a reception is provided in the bracket on the side of the locking element, in which reception the locking element is retained. The reception may be open on one side for example, in order to guide the locking element into the reception. A cost-advantageous mounting and/or dismounting is thereby made possible. In order to increase the ease of operation of the inventive system even more, at least one indicator may be provided which displays information on whether the locking element is located in the locking position and/or in the releasing position. The indicator provides visual information to the user on the current condition of the inventive system, in particular on the fact whether the inventive system is in the interlocking condition or in the unlocking condition. The indicator may communicate the respective information to the user by colors, in particular the color green could represent the unlocking condition and the colour red could indicate the interlocking condition of the locking mechanism. As an alternative and/or in addition, it may be provided that the handle has an indicator as well, which displays information on whether the handle is in the closing position thereof and/or in the opening position. Corresponding to the indicator of the locking element, the indicator of the handle may function analogously with colours. The inventive system likewise comprises that the indicator offers information to the user which, via numerals and/or letters and/or pictograms and/or images, provide a statement with regard to the interlocking and/or unlocking conditions of the sliding door, in particular of the handle and/or the locking mechanism.

Advantageously, the handle is configured as a rotary knob. Furthermore, the rotary knob is advantageously disposed on the inside of the sliding door. A potential mechanical emergency unlocking option may be provided for the exterior area of the sliding door, in that, instead of the rotary knob, an auxiliary contour is present, which is accessible from outside. The auxiliary contour can be moved by a suitable tool, whereby the same mechanical effect can be achieved within the handle as would be by actuating the handle from the interior area of the sliding door. The auxiliary contour may be configured for example as a slot, in which for example a coin can be inserted in order to move the slot, whereby the lever element disposed in the handle is correspondingly moved. The mechanical emergency unlocking from the exterior area of the sliding door can thus be achieved by the auxiliary contour.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further advantages, features and details of the invention will result from the following description, in which exemplary embodiments of the invention are described in detail, reference being made to the drawings. In this context, the features mentioned in the claims and in the description, individually or randomly combined, may be essential to the invention. In the drawings:

FIG. 1: shows a diagrammatical three-dimensional view on an inventive system for interlocking and unlocking a sliding door;

FIG. 2: shows the inventive system according to FIG. 1 in a further view;

FIG. 3: shows an exemplary embodiment of a handle for an inventive system according to FIG. 1;

FIG. 4: shows an exemplary embodiment of a handle, which is located in the closing position;

FIG. 5: shows a further sectional view on the handle according to FIG. 4, wherein a locking element is located in the locking position;

FIG. 6: shows the handle according to FIG. 4 in an opening position;

FIG. 7: shows a further illustration of an inventive system for interlocking and unlocking a sliding door with a locking mechanism, which is disposed at a wall side;

FIG. 8: shows an elevated view on the locking mechanism according to FIG. 7, wherein the locking element of the locking mechanism is located in the locking position;

FIG. 9: shows the locking mechanism according to FIG. 8, wherein the locking element is located in the releasing position;

FIG. 10: shows the locking mechanism according to FIG. 8 in the situation of an emergency unlocking;

FIG. 11: shows an elevated view according to the locking mechanism of FIG. 10; and

FIG. 12: shows a further view on an inventive system.

### DETAILED DESCRIPTION OF THE PRESENTLY PREFERRED EMBODIMENTS

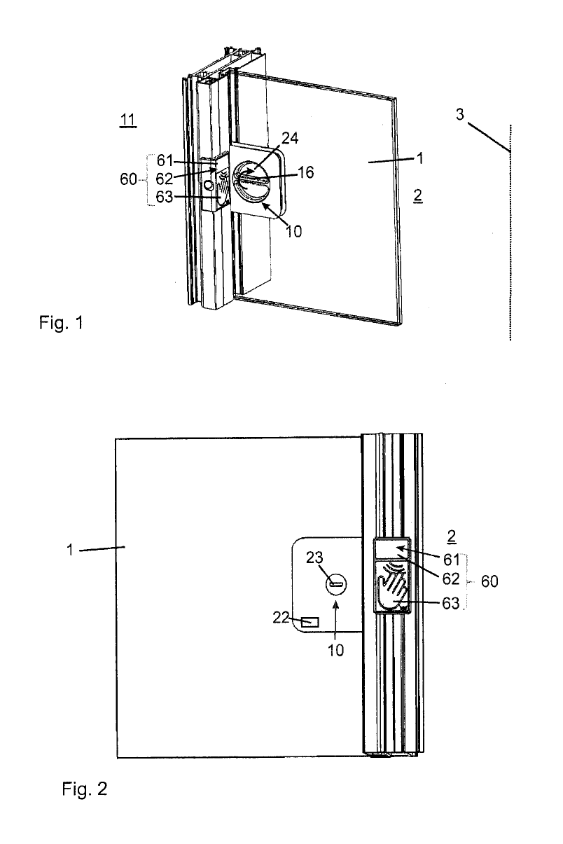

An inventive system for interlocking and unlocking a sliding door 1 is shown in FIG. 1 and FIG. 2. FIG. 1 shows the system from a perspective, in which the user is located in the interior area of the sliding door 1. FIG. 2 shows the system from a perspective, in which the user is located in the exterior area of the sliding door 1. FIG. 1 and FIG. 2 illustrate a handle 10, which is a component of a door fitting. The handle 10 is illustrated in the closing position 11. The handle 10 is located within the sliding door 1, wherein the handle 10 is disposed to be essentially flush-mount on the door 1. On the inside, the handle 10 has a knob 16, which is located in a knob depression 24 of the handle 10. The handle 10 can be manually moved clockwise from the closing position 11 into an opening position which is not explicitly illustrated.

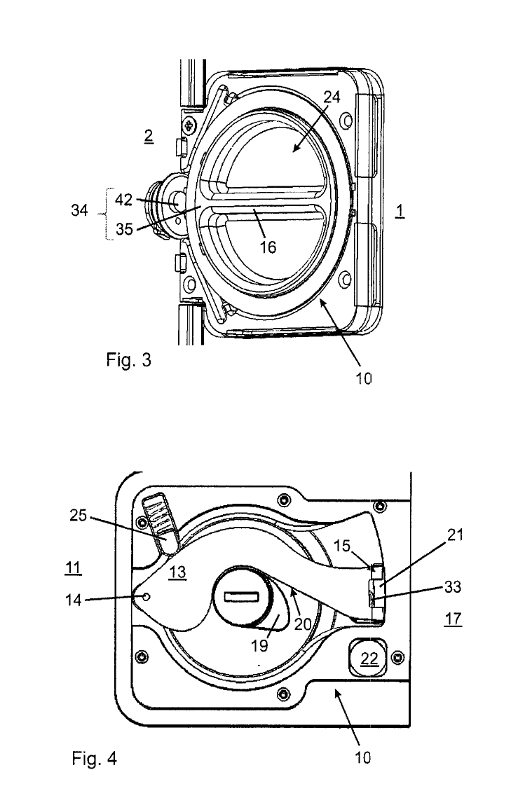

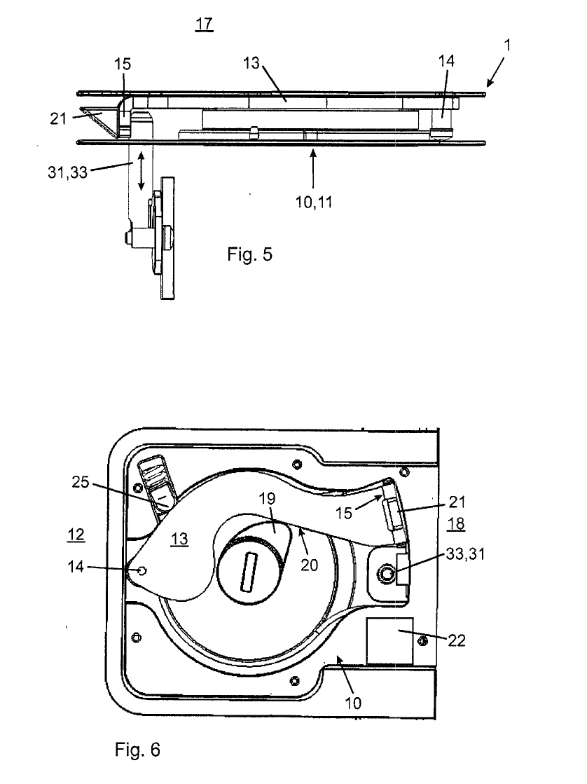

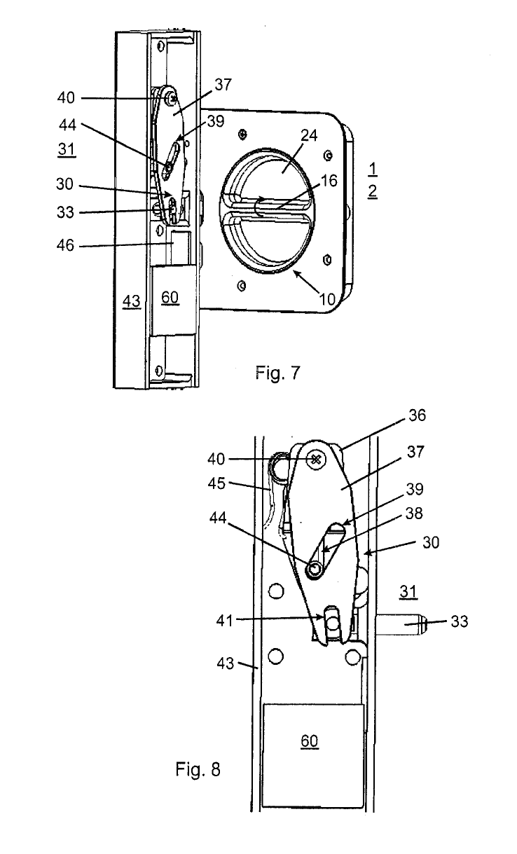

FIG. 7 illustrates that the handle 10 cooperates with a locking mechanism 30 which is disposed on the wall side. The locking mechanism 30 features an electronic drive 50, which is illustrated in FIG. 12. Moreover, the locking mechanism 30 comprises a locking element 33, which is located in a locking position 31 in FIG. 7, in which a movement of the sliding door 1 from its closed location 2 in the direction of the opening location is blocked, which is likewise illustrated in FIG. 4 and FIG. 5. According to FIG. 6, the handle 10 can be moved into an opening position 12, wherein in case of a rotation of the handle 10, a cam 19 acts upon a crescent-shaped contour 20 of the lever element 13, whereby the lever element 13 is pivoted about an axis 14.

At the side facing the locking element 33, the lever element 13 has a contact surface 14, which, in the closing position 11 of the handle 10, engages at the locking element 33, which is illustrated in FIG. 4 and FIG. 5. In the illustrated exemplary embodiment, the contact surface 15 is angled with regard to the rest of the lever element 13, wherein the contact surface 15 is angled by 90° with regard to the rest of the lever element 13. In the opening position 12 of the lever element 13 according to FIG. 6, the contact surface 15 is spaced apart from the locking element 33, which is located in the locking position 31. In the opening position 12 of the lever element 13, the user is able to manually displace the sliding door 1 to the left into the opening location 3, because the system is in the unlocking condition. FIG. 6 shows, in addition, that the lever element 13 is spring-loaded, in particular a spring element 25 acting upon the lever element 13.

FIG. 3 shows a further exemplary embodiment, in which sensory electronics 34 are provided, which recognize the position 11, 12 of the handle 10. Depending on the position 11, 12 of the handle 10, the locking element, which is not explicitly shown in FIG. 3, is electronically movable between the locking position 31 and the releasing position 32. In the present exemplary embodiment, the sensory electronics 34 feature a magnetic element 35, which is disposed on the inside of the handle 10, in particular within the knob 16. Moreover, the sensory electronics 34 comprise a sensor element 42, which is suitable to detect the position of the magnetic element 35. The magnetic element 35 is secured to the knob 16, such that a movement of the knob 16 will move the magnetic element 35 along. The sensor element 42 is located on the wall side and is spaced apart from the knob 16. The sensor element 42 may consist, for example, of a Hall sensor. It is likewise conceivable to configure the sensor element 42 as a magnetic switch. In a further non-illustrated embodiment alternative, the invention comprises the provision that the sensory electronics 34 feature a micro-switch on the wall side, which can be actuated by a movement of the handle 10.

According to FIG. 1 and FIG. 2, it is illustrated that the inventive system features a sensor module 60, which has a defined detection area in order to recognize a user. In the event the sensor module 60 has detected a user, the electronic drive 50 of the electro-mechanical locking mechanism 30 is activated, in order to move the locking element 33 into one of its two positions 31, 32. The sensor module 60 may feature a touch sensor or a proximity sensor. In the present exemplary embodiment, respectively one sensor module 60 is located on the inside (FIG. 1) and on the outside (FIG. 2). The sensor module 60 has two fields 62, 63. The field 63 is responsible for the detection of the user. The field 62 has an indicator 61, which displays information to the user on whether the sliding door 1 is locked and/or unlocked. An interlocking is given, if the locking element 33 is in the locking position 31 and the handle 10 is located in the closing position 11. Thus, a movement of the sliding door from the closed location 2 in the direction of the opening location 3 is not possible. Unlocking the sliding door 1 is given, if the handle 10 is located in the opening position 12 and the locking element 33 is still in the locking position 31 (see FIG. 6). Transferring the handle 10 into the above mentioned opening position 12 is effected manually, respectively by hand, in particular from the inside of the sliding door 1 and/or the outside of the sliding door 1. For transferring the handle 10 into the opening position 12, according to FIG. 2, the handle 10 features an auxiliary contour 23 which is configured to be slot-like. The auxiliary contour 23 can be moved by a special tool, which is utilized for example in the event of an emergency opening.

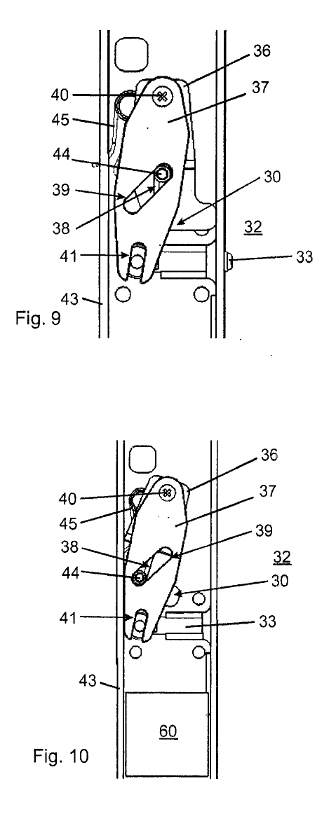

An unlocking condition of the sliding door 1 may be likewise given, if the handle 10 is located in the closing position 11, for example as in FIG. 4, however, the locking mechanism 30 has electronically moved the locking element 33 into the releasing position 32, which is shown in FIG. 9. When moving the sliding door 1 in the direction of the opening location 3, the handle 10 as well as the locking element 33 can no longer collide.

In FIG. 7 the locking mechanism 30 is shown, which is disposed at a wall side within a housing 43. The sensor module 60 is outlined, which is responsible for detecting the user, as already described in FIG. 1 and FIG. 2. Electronics 46, which for example may feature a microprocessor, control units, a printed circuit board, and an energy accumulator are additionally disposed within the housing 43. The functioning of the locking mechanism is illustrated in FIG. 8 to FIG. 11 and will be discussed in the following. According to FIG. 8, the locking element 33 is located in the locking position 31, in which the sliding door 1 with the handle 10 cannot be moved out of the closed location 2. According to FIG. 12 the drive 50 is located on the support element 36. The drive 50 may consist of an electric motor which is connected to a cam 44. The cam 44 connects the support element 36 to a bracket 37 which is spaced apart therefrom. The bracket 37 has a first guiding contour 38 and the support element 36 has a second guiding contour 39. In the present exemplary embodiment, both guiding contours 38, 39 are configured as an oblong hole in which the cam 44 is able to move. Based on FIG. 8, a movement of the locking element 33 from the locking position 31 into the releasing position 32 (see FIG. 9) is realized in that the drive 50 moves the cam 44 upwards in the direction of the pivoting axis 40. As the second guiding contour 39 of the bracket 37 is oriented at a slant with regard to the first guiding contour 38 of the support element 36 (see FIG. 8), the bracket 37 pivots clockwise about the axis 40, wherein the support element 36 remains immobile in its position. The bracket 37 has a reception 41 in which the locking element 33 is retained. As the bracket 37 pivots into the position according to FIG. 9, the locking element 33 is simultaneously moved into the retracted releasing position 32. The support element 36 is spring-loaded by a spring 45, wherein the spring force acts to the right side.

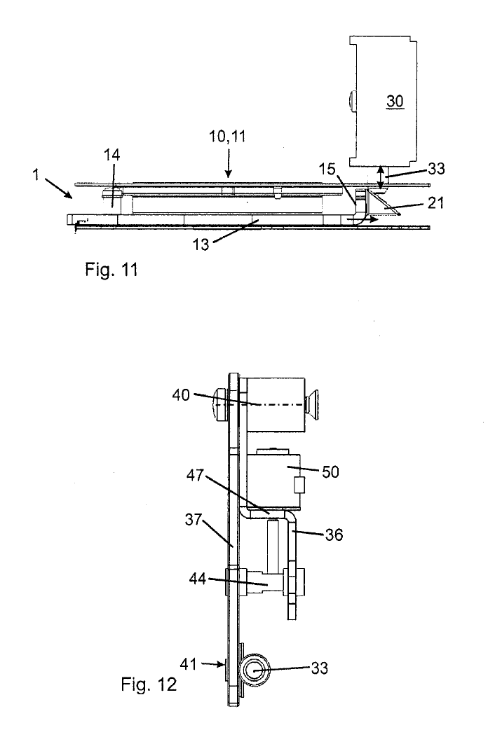

Now the following case may occur, namely that the locking element 33 is located in the locking position 31 and the sliding door 1 is in the opening location 3. If, in such a situation, for example an electronic control of the locking mechanism 30, respectively of the electronic drive 50, is not possible, for example on account of a power failure, according to FIG. 10 and FIG. 11, the locking mechanism 30 can include an emergency-unlocking. This is realized in that, during a movement of the sliding door in the direction of the closed location 2, on account of the action of force of the sliding door 1, the locking element 33 is moved from the locking position 31 into the releasing position 32. FIG. 10 shows that, on account of the action of exterior force on the locking element 33, both the bracket 37 and the support element 36 are pivoted clockwise about the axis 40, wherein simultaneously the cam 44 remains in its position within the two guiding contours 38, 39. According to FIG. 11, it is shown that the lever element 13 features an end piece 21 in the area of a contact surface 15, which is configured to be slanted with regard to the locking element 33. In the present exemplary embodiment, the end piece 21 is made from plastic material, wherein the lever element 30 is made from metal. Via the ramp of the end piece 21, the locking element 33 is pushed into the housing 43 of the locking mechanism 30 in the direction of the releasing position 32. If the sliding door 1 has reached its closed location 2, according to FIG. 10, the spring 45 effects that the locking element 33 is displaced into the locking position 31 as already shown in FIG. 5.

It is shown according to FIG. 4 and FIG. 5 that the lever element 13 can be manually moved between a blocking position 17 and a releasing position 18 via the actuation of the handle 10. In the blocking position 17 according to FIG. 4, a movement of the sliding door 1 cannot occur, if the locking element 33 is located in the locking position 31. It is only once the locking element 33 has reached the releasing position 32, that a movement of the sliding door 1 can be performed in the direction of the opening location 3, even if the lever element 13 is in the blocking position 17.

According to FIG. 12, the support element 36 features a step-like contour with a support surface 47 for the drive 50.

In the releasing position 18 according to FIG. 6, a movement of the sliding door 1 in the direction of the opening location 3 is possible, independently of whether the locking element 33 is in the locking position 31 or in the releasing position 32.

It is conceivable according to FIG. 1 and FIG. 2, that an indicator 22 be provided at the handle 10, which displays the position 11, 12 of the handle 10. The indicator 22 may correspond to the embodiments of the indicator 61 of the sensor module 60.

It is furthermore conceivable that the sensor module 60 is connected to an electronic drive, which is not explicitly shown, in order to effect an automatic movement of the sliding door 1 between the closed location 2 and the opening location 3. It is furthermore conceivable that the sensor module 60 is able to receive instructions from the user via voice recognition and is able to further process the instructions, so that corresponding actions of the locking mechanism 30 may occur. In one potential embodiment of the invention, the sliding door 1 consists of a door having a very small door thickness, in particular a glass door. In addition or as an alternative, it is conceivable that such a system will find its application in particular with cubicle doors and/or washroom doors.

The invention is not limited with respect to its construction to the preferred embodiment example indicated in the preceding. On the contrary, there are a number of conceivable variants which can be made use of by the demonstrated solution also in fundamentally different arrangements. All of the features and/or advantages, including constructional details or spatial arrangements, stemming from the claims, the description or the drawings may be essential to the invention both by themselves and in the most widely varying combinations. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for interlocking and unlocking a sliding door (1), comprising:
a handle (10), attachable flush-mountably to the sliding door (1), having:
an electro-mechanical locking mechanism (30) attachable in a wall-mount manner, and having a movable locking element (33) movable between a protracted locking position (31) and a retracted releasing position (32), and
an electronic drive (50), incorporated into the locking mechanism (30) and in operative connection with the locking element (33), wherein the handle (10) is manually movable between an opening position (12) and a closing position (11), the handle (10) and the locking mechanism (30) cooperating such that, in the locking position (31) of the locking element (33) and in the closing position (11) of the handle (10), a movement of the sliding door (1) from a closed location (2) in the direction of an opening location (3) can be blocked and, in the opening position (12) of the handle (10), a movement of the sliding door (1) can be effected from the closed location (2) in the direction of the opening location (3); and
at least one manually accessible sensor module (60), which has a defined detection area in data communication with the electronic drive (50) such that a detection of a user in the detection area will move the locking element (33) into at least one of the protracted locking position (31) and the retracted releasing position (32).

2. The system according to claim 1, wherein the sensor module (60) comprises a touch sensor and/or a proximity sensor, the sensor module (60) being configured to recognize at least one defined pattern of movement of the user.

3. The system according to claim 2, wherein the handle (10) is actuatable from both sides of the sliding door (1).

4. The system according to claim 1, wherein the handle (10) and the locking mechanism (30) cooperate such that, in the locking position (31) of the locking element (33), a transfer of the handle (10) into the opening position (12) can be effected, whereby a movement of the sliding door (1) from the closed location (2) into the opening location (3) is enabled.

5. The system according to claim 1, further comprising sensor electronics (34) configured to recognize the position (11, 12) of the handle (10), whereby, depending on the position (11, 12) of the handle (10), the locking element (33) is electronically movable between the locking position (31) and the releasing position (32).

6. The system according to claim 5, wherein the sensor electronics (34) comprise a micro-switch actuatable by a movement of the handle (10).

7. The system according to claim 5, wherein the sensor electronics (34) comprise: (a) a magnetic element (35) disposed at the handle (10), and (b) a sensor element (42) configured to detect a position of the magnetic element (35).

8. The system according to claim 7, wherein the sensor element (42) is a magnetic switch or a Hall sensor.

9. The system according to claim 1, further comprising a movable lever element (13) mechanically connected to the handle (10), the movable lever element (13), in the closing position (11) of the handle (10), being blocked by the locking element (33) in the locking position (31) from moving with the sliding door (1) from the closing position (11) in the direction of the opening position (12).

10. The system according to claim 9, wherein the lever element (13) is pivotally movable about an axis (14) by a movement of the handle (10) into its respective closing and opening positions (11, 12).

11. The system according to claim 10, wherein the lever element (13) comprises a crescent-shaped contour (20) into which the handle (10) engages during movement of the handle (10).

12. The system according to claim 9, wherein the lever element (13), at a side facing the locking element (33), comprises a contact surface (15), which, in the closing position (11) of the handle (10), engages in, contacts the locking element (33), when the locking element (33) is in the locking position (31).

13. The system according to claim 12, wherein the contact surface (15) is angled with respect to the rest of the lever element (13).

14. The system according to claim 9, wherein the handle (10) is in operative connection with the lever element (13) such that, in the opening position (12) of the handle (10), the lever element (13) is disengaged from the locking element (33) in the locking position (31), such that a movement of the sliding door (1) from the closed location (2) into the opening location (3) can be performed.

15. The system according to claim 1 wherein the locking mechanism (30) comprises a support element (36) at which a drive (50) is disposed, the drive (50) being in operative connection with a movable bracket (37).

16. The system according to claim 15, wherein the bracket (37) is connected to the support element (36) via a cam (44), which is in operative connection with the drive (50), wherein in particular the bracket (37) comprises a first guiding contour (38) and the support element (36) comprises a second guiding contour (39), the cam (19) being supported to be movable in both the first and second guiding contours (38, 39).

17. The system according to claim 16, wherein the second guiding contour (39) is oriented at a slant with respect to the first guiding contour (38).

18. The system according to claim 15, wherein the bracket (37) is supported to be rotatable about an axis (40) disposed at a side of the bracket (37) facing away from the locking element (33).

19. The system according to claim 18, wherein the bracket (37) has a reception (41), on the side of the locking element, in which reception the locking element (33) is retained.

20. The system according to claim 1, further comprising at least one indicator (22) configured to display information as to whether the locking element (33) is located in the locking position (31) and/or in the releasing position (32).

21. The system according to claim 15, wherein the bracket (37) is pivotable together with the support element (36) for an emergency unlocking action.
